(19) United States
(12) Patent Application Publication
(10) Pub. No.: US 2006/0191982 A1
(43) Pub. Date: Aug. 31, 2006

(54) Process for producing a metallic honeycomb body with a layer length difference

(75) Inventors: Rolf Bruck, Bergisch Gladbach (DE); Kait Althofer, Wiehl (DE); Jan Hodgson, Troisdorf (DE); Wilfried Muller, Lindlar (DE)

Correspondence Address: LERNER GREENBERG STEMER LLP, P O BOX 2480, HOLLYWOOD, FL, 33022-2480, US

(73) Assignee: Emitec Gesellschaft fur Emissionstechnologie mbH

(21) Appl. No.: 11/396,991

(22) Filed: Apr. 3, 2006

Related U.S. Application Data
(63) Continuation of application No. PCT/EP04/10451, filed on Sep. 17, 2004.

(30) Foreign Application Priority Data
Oct. 2, 2003 (DE) DE 103 45 910.3

(51) Int. Cl. B23K 31/02

(52) U.S. Cl. 228/181

(57) ABSTRACT

A method for producing a metallic honeycomb body includes providing a plurality of smooth sheet-metal foils and at least partly structured sheet-metal foils and placing the foils in a housing. The smooth sheet-metal foils have a first length while the structured sheet-metal foils have a second length. A difference between the first length and the second length is selected in accordance with a prestress.

### CROSS-REFERENCE TO RELATED APPLICATIONS

This is a continuing application, under 35 U.S.C. §120, of copending International Application No. PCT/EP2004/010451, filed Sep. 17, 2004, which designated the United States; this application also claims the priority, under 35 U.S.C. §119, of German Patent Application No. 103 45 910.3, filed Oct. 2, 2003; the prior applications are herewith incorporated by reference in their entirety.

### BACKGROUND OF THE INVENTION

### Field of the Invention

The invention relates to a process for producing a metallic honeycomb body, which has a plurality of smooth sheet-metal foils and at least partially structured sheet-metal foils and is disposed in a housing. The smooth sheet-metal foils have a first length, and the structured sheet-metal foils have a second length.

Such metallic honeycomb bodies are used in particular as carrier bodies for a catalytically active coating, an adsorbent coating, an oxidizing coating, a reducing coating or a coating with a similar action in exhaust systems of mobile internal combustion engines. Due to the extreme thermal and dynamic stresses encountered in such systems, it is particularly important to ensure a permanent connection between the individual sheet-metal foils as well as between the sheet-metal foils and the housing. The sheet-metal foils are usually connected to one another and to the housing by technical joining, in particular by sintering, brazing and/or welding. For that purpose, it is necessary for sufficient contact locations between the adjacent sheet-metal foils and/or between the sheet-metal foils and the housing at the desired connection locations to serve as a basis for a connection by technical joining.

In order to ensure a stable connection of the sheet-metal foils to the housing, European Patent EP 0 245 737 B1, corresponding to U.S. Pat. Nos. 4,832,998, 4,803,189, 4,946,822 and 4,923,109, reveals that shortening the corrugated sheet-metal layers by a predetermined distance compared to the smooth sheet-metal layers, ensures that all of the ends of the sheet-metal layers are in contact with the tubular casing and nestle against it. Due to that structure, it is easier to effect a secure connection to the tubular casing at various contact angles.

### SUMMARY OF THE INVENTION

It is accordingly an object of the invention to provide a process for producing a metallic honeycomb body with a layer length difference, which overcomes the hereinafore-mentioned disadvantages of the heretofore-known processes of this general type, which is used to produce metallic honeycomb bodies that can be used for a prolonged period of time and which, in particular, is intended to allow reliable determination of the layer length difference for different cross-sectional shapes of the honeycomb body and/or different configurations.

With the foregoing and other objects in view there is provided, in accordance with the invention, a process for producing a metallic honeycomb body. The process comprises providing a plurality of smooth sheet-metal foils and at least partially structured sheet-metal foils. The smooth sheet-metal foils are provided with a first length, and the structured sheet-metal foils are provided with a second length. A difference between the first length and the second length is selected as a function of a prestress. The sheet-metal foils are placed in a housing.

By way of explanation, it should be noted herein that the sheet-metal foils are usually wound or intertwined in such a way that they have an external shape which substantially corresponds to the shape of the housing. The body which has been preshaped from the sheet-metal foils in this way is introduced into the tubular casing and there seeks to expand again. As a result, the ends of the sheet-metal foils are pressed onto an inner lateral surface of the housing.

It is now proposed that the external shape of the sheet-metal stack have a cross section which, based on its surface area, is a certain proportion larger than the cross-sectional area of the housing delimited by the inner lateral surface of the housing. This means that it is not possible for the sheet-metal foil stack to be introduced into inner regions of the housing without the sheet-metal foil stack being in contact with the inner lateral surface of the housing. The excess area is preferably in a range of less than 10%, in particular in a range of from 2 to 8%, with the result that when the sheet-metal foil stack is being introduced into the housing, a force or pressure, referred to herein as the “prestress”, is exerted at the periphery. In this context, the excess surface area is a suitable characteristic value representing a measure of the prestress. Accordingly, in the text which follows, a prestress of, for example, 5% is to be understood as meaning that the cross section of the sheet-metal stack is 5% larger in terms of its area than the cross section of the housing which is delimited by its inner lateral surface. The prestress is to be selected as a function of the field in which the honeycomb body is used. Furthermore, under certain circumstances the shape of the housing or how many and what type of sheet-metal foils are used should also be taken into account. If the prestress has now been determined, it is proposed that the layer length difference or the difference between the first length and the second length be selected as a function of this prestress. This dependent relationship may be linear or nonlinear in form. Further details thereof will be given below.

In accordance with another mode of the invention, at least one of the following parameters is taken into account when determining the difference between the first length and the second length:
thickness of the sheet-metal foils;
material of the sheet-metal foils;
height of the structured sheet-metal foils;
side inclination of the structured sheet-metal foils;
width of the structure of the structured sheet-metal foils;
ratio of width and height of the structure of the structured sheet-metal foils;
cell density;
surface friction coefficients of the sheet-metal foils; and
diameter of the honeycomb body.

The thickness and/or material of the sheet-metal foils should be taken into account, since they have a crucial influence on the deformation properties of the sheet-metal foils. If thicker sheet-metal foils are used, less deformation upon introduction of the sheet-metal foils is usually likely. The same is true with regard to the material. If less deformation of the sheet-metal foils occurs, the layer length difference does not have to be as great. The height, the side inclination, the width and/or the ratio of width and height of the structure likewise have a considerable influence on the rigidity of the metallic honeycomb body. Relatively flat structures can be compressed more easily, so that in this case increasing lengthening of the structured sheet-metal foil is likely when the sheet-metal foil stack is introduced into the tubular casing. Accordingly, the layer length differences also have to be selected to be greater. Tests have shown that the cell density is another relevant variable. Specifically, higher cell densities tend toward a greater layer length difference. Due to the fact that the sheet-metal foils disposed adjacent one another slide along one another when they are being introduced into the housing, the surface friction coefficients of the sheet-metal foils are likewise important. A low surface friction coefficient means that the sheet-metal foils slide along one another more easily and a greater layer length difference has to be ensured.

In accordance with a further mode of the invention, a correction value is taken into account when determining the difference between the first layer and the second layer. This correction value represents, for example, a tolerance band, which is of importance in particular with a view toward series production of metallic honeycomb bodies of this type. The correction value is preferably in a range of less than 1.3 mm and can be added to or subtracted from the determined layer length difference.

In accordance with an added mode of the invention, the difference Δ1 between the first length and the second length is determined in accordance with the following formula:

$$Δ1 = \frac{{Z}_{H}}{{Z}_{G}} [ \frac{{m}_{1} {l}_{0}}{p} ( {h}_{0} - {m}_{3} {σ}_{v} ) + {b}_{1} ] + \frac{{Z}_{W}}{{Z}_{G}} [ \frac{{m}_{2} {l}_{0}}{p} ( {h}_{0} - {m}_{2} {σ}_{v} ) + {b}_{2} ]$$

where Z_{H}=proportion of “hard” cell connections;
Z_{W}=proportion of “soft” cell connections;
Z_{G}=total number of cells;
l₀=packet length (unstressed) in mm;
h₀=packet height (unstressed) in mm;
p=pitch in mm;
σᵥ=prestress;
mᵢσᵥ=reduction in corrugation height caused by the prestress
m=slope
b=intercept with x axis.

“Hard” cell connections and “soft” cell connections are to be understood as two different forms of behavior of the structured sheet-metal layers or the smooth sheet-metal layers. Hard cell connections are to be understood as meaning cell connections which do not change position with respect to one another during insertion. This means that the subregions of adjacent smooth and structured sheet-metal foils which are in direct contact with one another, for example, have not changed position relative to one another after insertion. By contrast, “soft” cell connections is a term used to describe the contact locations which slide along one another and therefore do change position relative to one another. The proportion of “hard” and “soft” cell connections depends mainly on the type of winding (spiral shape, S shape, etc.) and the cell shape itself. The term packet length is to be understood as meaning the mean length of the sheet-metal foil stack, while the packet height represents the overall height of the sheet-metal foil stack(s) in the stress-free state. The term pitch is to be understood as meaning the width of the structure. The prestress is preferably in a range of from 4 to 8%. The variables m and b depend on the foil thickness and the ratio of pitch and height of the corrugation.

Working on the basis of these relationships, the following trends can be assumed with regard to the layer length difference when varying the parameters. In the tables below, an upward arrow represents an increase/rise in the value and a downward arrow represents a decrease/drop in the value.

TABLE 1
Trends increasing the layer length difference

| | Layer length |
|---|---|
| Parameter | difference |
| Proportion of hard connections ↑ | ↑ |
| Cell density ↑ | ↑ |
| Prestress ↑ | ↑ |
| Type of winding ↑ | ↑ |
| Sliding abilities ↑ | ↑ |
| Honeycomb body diameter ↑ | ↑ |

TABLE 2
Trends reducing the layer length difference

| | Layer length |
|---|---|
| Parameter | difference |
| Proportion of soft connections ↑ | ↓ |
| Pitch/corrugation height ratio ↑ | ↓ |
| Foil thickness ↑ | ↓ |

In accordance with an additional mode of the invention, the structure of the honeycomb body, in particular at least one of the following characteristic values: type of winding, housing cross section, cell geometry, is also taken into account. The term “type of winding” refers to the profile of the sheet-metal foils when the sheet-metal foil stack or the honeycomb body is viewed end-on. Known types of winding include, for example, the helical shape, the S shape, the V shape and the W shape. Virtually every conceivable shape of housing cross section is known, in particular round, oval, polygonal or triangular shapes or mixed forms thereof. The cell geometry is substantially adapted to the passage cross section, in which context triangular, sinusoidal, rectangular, round or similar cell geometries are known.

In accordance with yet another mode of the invention, the process includes at least the following steps:
determining the difference between the first length and the second length;
selecting smooth sheet-metal foils having the first length and at least partially structured sheet-metal foils having the second length;
stacking smooth sheet-metal foils and structured sheet-metal foils in an alternating manner to form at least one stack; and
winding and/or intertwining the at least one stack;
introducing the at least one stack with a prestress into a housing, so that all of the ends of the smooth and structured sheet-metal foils are in contact with the housing.

This process is also explained in more detail below with reference to the figures. At this point, however, it should be noted that the process relates in particular to the production of a honeycomb body which is not helical in form. With the helical shape, one corrugated or one smooth metal sheet always bears virtually completely and over the entire circumference against the inner lateral surface of the housing. In that case, it is not so important for the end of the sheet-metal foil to be in contact, since other, large-area regions of the sheet-metal foil bear against the housing. In the configuration of a honeycomb body with a multiplicity of metal sheets, with each of these metal sheets having their ends bearing against the inner lateral surface of the housing, the contact locations between the sheet-metal foils and the housing are considerably smaller. In order to nevertheless ensure permanent connection of the sheet-metal foils to the housing, the layer length difference is to be selected in such a way that all of the ends are actually in contact with the housing. An end is to be understood as meaning in particular the last portion of a sheet-metal foil, extending for example over a length of less than 2 or 1 mm, if appropriate even only over a few tenths of a millimeter.

In accordance with yet a further mode of the invention, the at least one stack is bent in an S shape, V shape and/or U shape.

In accordance with yet an added mode of the invention, in particular also with a view toward a V-shaped or U-shaped configuration of the sheet-metal foils in the stack, a plurality of stacks are introduced into the housing. The other stacks are preferably positioned next to one another and then introduced simultaneously into the housing.

In accordance with yet an additional mode of the invention, a bonding agent is applied over an end side of the honeycomb body. Due to a capillary effect, the bonding agent is distributed along contact locations between the individual sheet-metal foils and between the sheet-metal foils and the housing. In this case, the bonding agent is preferably in actual fact distributed only in the vicinity of the contact locations, i.e. for example pockets which are formed between the sheet-metal layers disposed adjacent one another and/or between the ends of the sheet-metal foils and the housing. The bonding agent also has the function, for example, of fixing brazing material which is subsequently supplied at the contact locations until connections by technical joining are actually formed. The bonding agent is preferably selected in such a way that during a heat treatment of the honeycomb body it is converted into gaseous constituents and therefore does not impede the formation of brazing material connections, for example.

In accordance with again another mode of the invention, a brazing material is applied over an end side of the honeycomb body, and the honeycomb body is brazed at temperatures of from 1000° C. to 1300° C. and/or in vacuo. In this context, it is preferable to use a brazing material in powder form which is supplied from the end side and preferably adheres to a bonding agent. The type of brazing material is to be selected by taking the material used for the sheet-metal foils into account.

In accordance with a concomitant mode of the invention, the sheet-metal foil is provided with a carrier layer which is impregnated with a catalytically active material and then calcined. A recommended carrier layer of this type is in particular what is known as washcoat. This carrier layer is distinguished by a particularly rough surface which is fissured in such a way as to ensure intimate contact with, for example, exhaust gases. Moreover, the large-area metal sheets offer sufficient space for the provision of uniformly catalytically active materials, promoting conversion of pollutants contained in the exhaust gas.

Other features which are considered as characteristic for the invention are set forth in the appended claims. It is noted in this regard that the technical features disclosed in the dependent patent claims can be combined with one another in any desired, technologically appropriate way, irrespective of the way in which they are actually referred back to one another.

Although the invention is illustrated and described herein as embodied in a process for producing a metallic honeycomb body with a layer length difference, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagrammatic, end-elevational view of a honeycomb body according to the invention;

FIGS. 2A and 2B are end-elevational views of a sheet-metal foil stack illustrating the behavior of a honeycomb body under prestress;

FIG. 3 is an enlarged, fragmentary, end-elevational view of a honeycomb body in an edge region;

FIG. 4 is a further enlarged, fragmentary, cross-sectional view of a honeycomb body with a coating;

FIG. 5 is a partly broken-away, perspective view of a further embodiment of a honeycomb body according to the invention;

FIG. 6 is a cross-sectional view of yet another embodiment of a honeycomb body according to the invention; and

FIG. 7 is a group of elevational and perspective views diagrammatically depicting a sequence of a process for producing a honeycomb body according to the invention.

### DESCRIPTION OF THE PREFERRED EMBODIMENTS

Referring now in detail to the figures of the drawings which merely represent particularly preferred embodiments without, however, the invention being restricted thereto and first, particularly to FIG. 1 thereof, there is seen an end-elevational view of a honeycomb body 1 which includes a plurality of smooth sheet-metal foils 3 and at least partially structured sheet-metal foils 2 and is disposed in a housing 4. The smooth sheet-metal foils 3 and the structured sheet-metal foils 2 form passages 10 which extend virtually parallel to one another between two end sides 13. Reinforcing structures 20 are provided in order to increase stability of the illustrated honeycomb body 1.

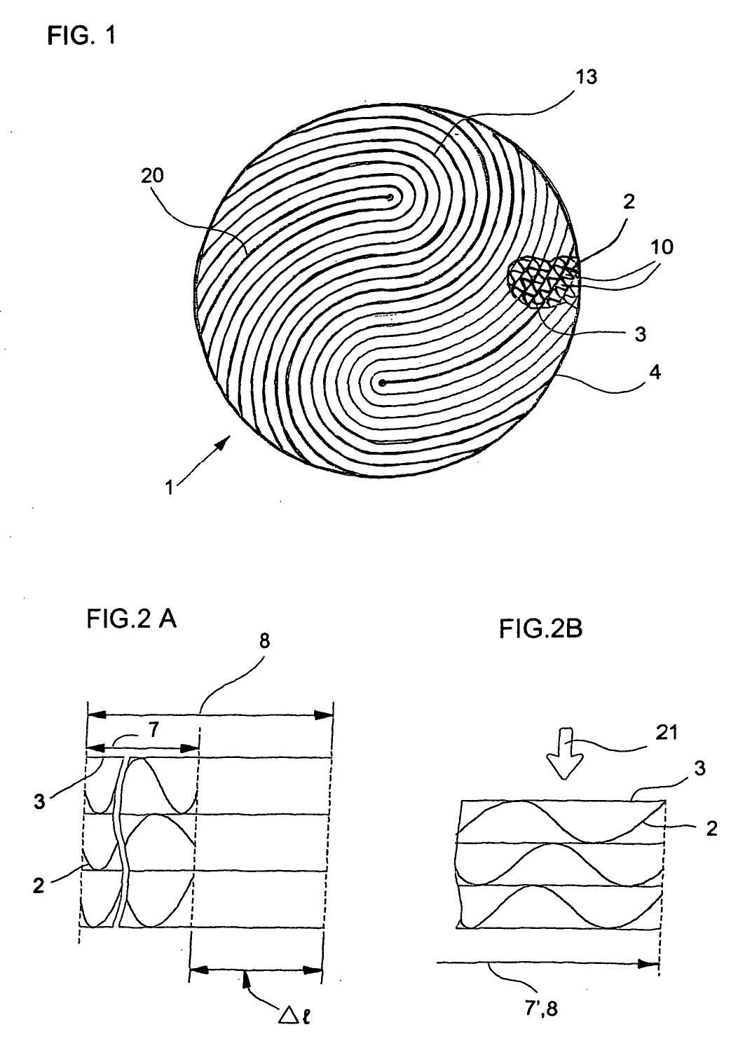

FIGS. 2A and 2B diagrammatically illustrate the behavior of a sheet-metal foil stack with smooth sheet-metal foils 3 and structured sheet-metal foils 2 under prestress 21. As is seen in FIG. 2A, the smooth sheet-metal foils 3 have a first length 8, and the structured sheet-metal foils 2 have a second length 7. A difference (Δ1) between the first length 8 and the second length 7 is selected as a function of the prestress 21. The difference between the first length 8 and the second length 7 is preferably less than 5 mm (in particular in a range from 1 to 3 mm). However, under certain circumstances, the second length 7 may also be greater than the first length 8. FIG. 2B shows that when a prestress 21 is applied, at least a change in the second length 7 takes place, since the structure is pressed flat. At the same time, however, it is also possible for the originally smooth sheet-metal foils 3 to adapt to a structure of the structured sheet-metal foils 2 and therefore likewise change their first length 8. Ultimately, however, the difference between the first length 8 and the second length 7 is such that when the prestress 21 is applied, all of the ends 17 bear against the housing 4.

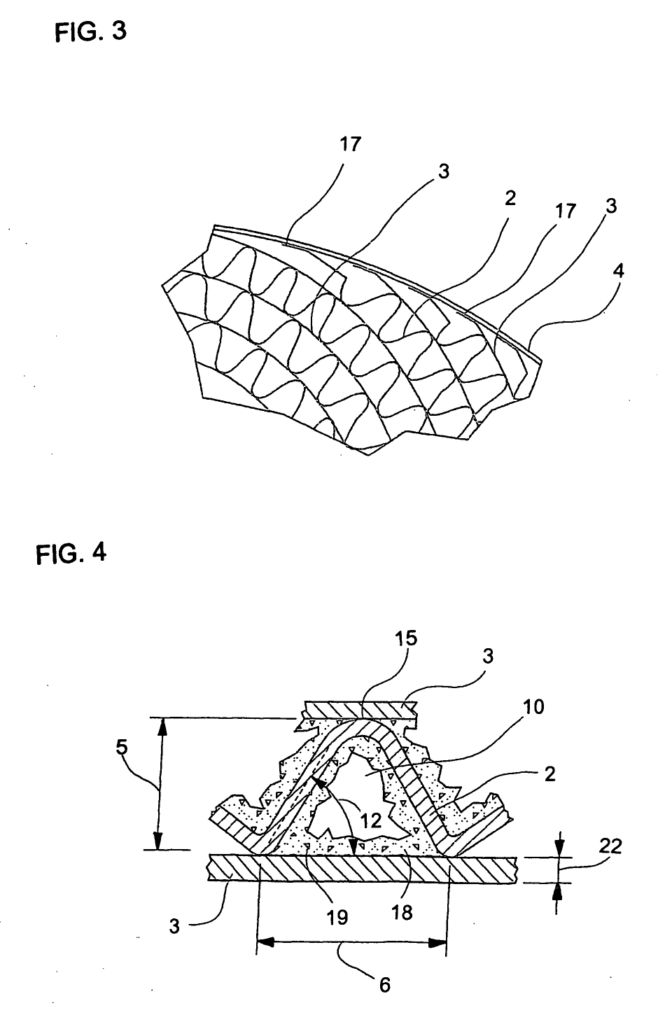

FIG. 3 is a fragmentary view diagrammatically illustrating precisely this bearing contact between ends 17 of the smooth sheet-metal foils 3 and the structured sheet-metal foils 2 against the housing 4.

FIG. 4 is a fragmentary view of a passage 10 which has been formed by smooth sheet-metal foils 3 and corrugated sheet-metal foils 2. The structure which at least partially forms the channel 10 is distinguished by a height 5 and a width 6. An angle formed by a side of the structure of the structured sheet-metal foil 2 and the smooth sheet-metal foil 3 defines a side inclination 12. The sheet-metal foils 2, 3 have a thickness 22 which is preferably less than 50 μm. In principle, it is possible for the structured sheet-metal foils 2 and the smooth sheet-metal foils 3 to have different thicknesses 22. The sheet-metal foils 2, 3 are connected to one another at contact locations 15. In the embodiment illustrated in this case, the honeycomb body 1 serves as a carrier body for a catalytically active coating. This coating includes a carrier layer 18, usually washcoat, which is doped with a catalyst 19. As an exhaust gas flows through the passage 10, it comes into intensive contact with the catalytically active coating, thereby effecting catalytically motivated conversion of pollutants contained in the exhaust gas.

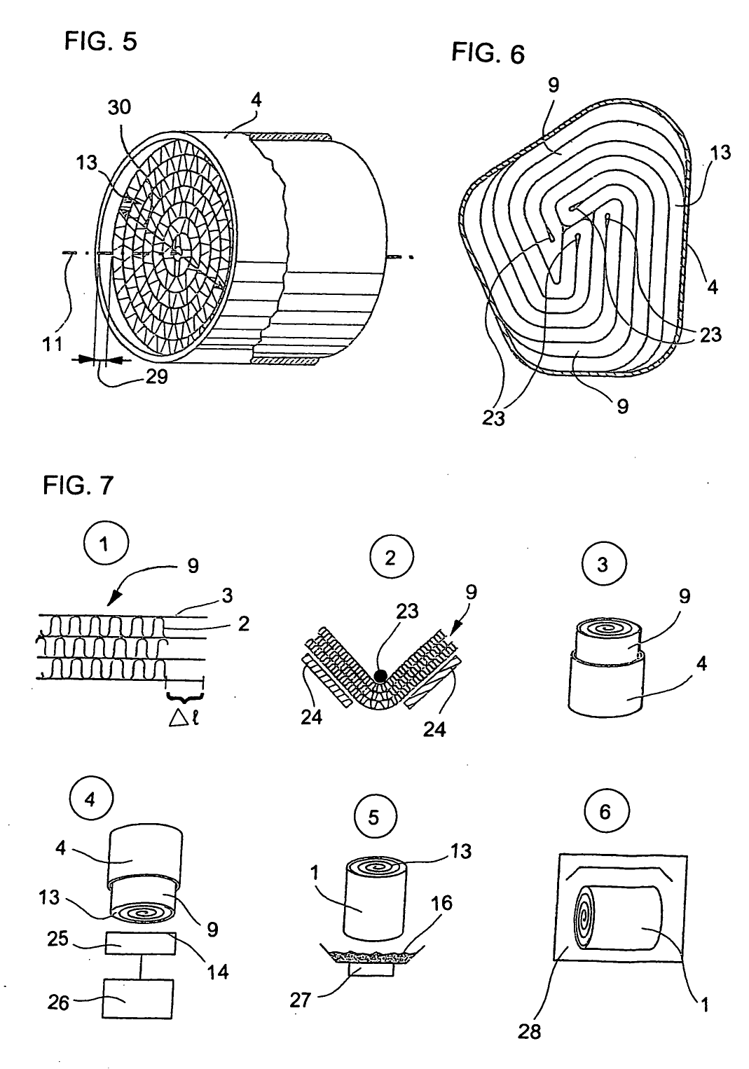

FIG. 5 shows a further form of winding of a honeycomb body 1. The sheet-metal foils 2, 3 in this case are wound up helically about an axis 11 and inserted into a housing 4. In this case, the housing 4 protrudes with a projection 29. The passages 10 once again extend substantially parallel to the axis 11 through the honeycomb body 1 from one end side 13 to the other. The honeycomb body 1 in this case has a diameter 30 which is preferably in a range of from 70 to 130 mm.

FIG. 6 shows a honeycomb body 1 which includes a plurality of stacks 9 disposed in the interior of the housing 4. In this case, the stacks 9 have been wound about a plurality of winding locations 23 and introduced into the housing 4.

FIG. 7 diagrammatically illustrates a sequence of one configuration of the process according to the invention. According to step 1, smooth sheet-metal foils 3 and structured sheet-metal foils 2 are layered alternately to form a stack 9. The smooth sheet-metal foils 3 have a first length 8, and the structured sheet-metal foils 2 have a second length 7. The stack 9 which is formed in this way is then bent about a winding location 23 with the aid of a tool 24, as is seen in step 2. One or more stacks 9 of this type are then at least partially introduced into a housing 4 in step 3. According to a variant illustrated in step 4, the stack 9 has not been completely introduced into the housing 4, but rather an uncovered end face has been brought into contact with a distributor 25 for distributing a bonding agent 14. Due to the capillary effect, the bonding agent 14 is sucked out of a reservoir 26, through the distributor 25, into the passages 10 in the honeycomb body 1 or stack 9. In accordance with step 5, the body 1 which has been prepared in this way is immersed in a fluidized bed 27 including brazing material 16. In the process, the brazing material 16 penetrates into inner regions of the honeycomb body 1 and adheres to the bonding agent 14. In order to form connections by technical joining, the honeycomb body 1 is conveyed into a furnace 28 and heat-treated at temperatures above 1000° C. and in vacuo, as is shown in FIG. 6.

We claim:

1. A process for producing a metallic honeycomb body, which comprises the following steps:
providing a plurality of smooth sheet-metal foils and at least partially structured sheet-metal foils;
providing the smooth sheet-metal foils with a first length, and providing the structured sheet-metal foils with a second length;
selecting a difference between the first length and the second length as a function of a prestress; and
placing the sheet-metal foils in a housing.

2. The process according to claim 1, which further comprises taking at least one of the following parameters into account when determining the difference between the first length and the second length:
thickness of the sheet-metal foils;
material of the sheet-metal foils;
height of the structured sheet-metal foils;
side inclination of the structured sheet-metal foils;
width of a structure of the structured sheet-metal foils;
ratio of width and height of the structure of the structured sheet-metal foils;
cell density;
surface friction coefficients of the sheet-metal foils; and
diameter of the honeycomb body.

3. The process according to claim 1, which further comprises taking a correction value into account when determining the difference between the first length and the second length.

4. The process according to claim 1, which further comprises determining the difference Δ1 between the first length and the second length in accordance with the following formula:
$$Δ1 = \frac{{Z}_{H}}{{Z}_{G}} [ \frac{{m}_{1} {l}_{0}}{p} ( {h}_{0} - {m}_{3} {σ}_{v} ) + {b}_{1} ] + \frac{{Z}_{W}}{{Z}_{G}} [ \frac{{m}_{2} {l}_{0}}{p} ( {h}_{0} - {m}_{2} {σ}_{v} ) + {b}_{2} ]$$
where Z_{H}=proportion of hard cell connections
Z_{W}=proportion of soft cell connections
Z_{G}=total number of cells
l₀=packet length in mm
h₀=packet height in mm
p=pitch in mm
σᵥ=prestress
mᵢσᵥ=reduction in corrugation height caused by the prestress
m=slope
b=intercept with x axis.

5. The process according to claim 1, which further comprises taking a structure of the honeycomb body into account when determining the difference between the first length and the second length.

6. The process according to claim 1, which further comprises taking at least one of the following characteristic values:
type of winding;
housing cross section; cell geometry;
into account when determining the difference between the first length and the second length.

7. The process according to claim 1, which further comprises performing at least the following steps:
determining the difference between the first length and the second length;
selecting smooth sheet-metal foils having the first length and at least partially structured sheet-metal foils having the second length;
stacking smooth sheet-metal foils and structured sheet-metal foils in an alternating manner to form at least one stack;
winding and/or intertwining the at least one stack; and
introducing the at least one stack with a prestress into the housing, causing all of the ends of the smooth and structured sheet-metal foils to be in contact with the housing.

8. The process according to claim 7, which further comprises bending the at least one stack into at least one shape selected from the group consisting of an S shape, a V shape and a U shape.

9. The process according to claim 7, which further comprises introducing a plurality of stacks into the housing.

10. The process according to claim 8, which further comprises introducing a plurality of stacks into the housing.

11. The process according to claim 7, which further comprises applying a bonding agent over an end side of the honeycomb body, and distributing the bonding agent, due to capillary effect, along contact locations between individual sheet-metal foils and between the sheet-metal foils and the housing.

12. The process according to claim 8, which further comprises applying a bonding agent over an end side of the honeycomb body, and distributing the bonding agent, due to capillary effect, along contact locations between individual sheet-metal foils and between the sheet-metal foils and the housing.

13. The process according to claim 9, which further comprises applying a bonding agent over an end side of the honeycomb body, and distributing the bonding agent, due to capillary effect, along contact locations between individual sheet-metal foils and between the sheet-metal foils and the housing.

14. The process according to claim 10, which further comprises applying a bonding agent over an end side of the honeycomb body, and distributing the bonding agent, due to capillary effect, along contact locations between individual sheet-metal foils and between the sheet-metal foils and the housing.

15. The process according to claim 11, which further comprises applying a brazing material through an end side of the honeycomb body, and brazing the honeycomb body at temperatures of from 1000° C. to 1300° C. and/or in vacuo.

16. The process according to claim 12, which further comprises applying a brazing material through an end side of the honeycomb body, and brazing the honeycomb body at temperatures of from 1000° C. to 1300° C. and/or in vacuo.

17. The process according to claim 13, which further comprises applying a brazing material through an end side of the honeycomb body, and brazing the honeycomb body at temperatures of from 1000° C. to 1300° C. and/or in vacuo.

18. The process according to claim 14, which further comprises applying a brazing material through an end side of the honeycomb body, and brazing the honeycomb body at temperatures of from 1000° C. to 1300° C. and/or in vacuo.

19. The process according to claim 7, which further comprises providing the sheet-metal foils with a carrier layer being impregnated with a catalytically active material and then calcined.

20. The process according to claim 9, which further comprises providing the sheet-metal foils with a carrier layer being impregnated with a catalytically active material and then calcined.
